(19) United States
(12) Patent Application Publication
(10) Pub. No.: US 2012/0223041 A1
(43) Pub. Date: Sep. 6, 2012

(54) ADJUSTABLE STORAGE RACK

(75) Inventor: James LEE, Old Tappan, NJ (US)

(73) Assignee: Organize-it-All Inc., Bogota, NJ (US)

(21) Appl. No.: 13/408,500

(22) Filed: Feb. 29, 2012

Related U.S. Application Data
(60) Provisional application No. 61/449,264, filed on Mar. 4, 2011.

(51) Int. Cl. A47B 96/02; B23P 11/00; A47B 96/06

(52) U.S. Cl. 211/150; 211/134; 29/428; 29/525.08

(57) ABSTRACT

A shelving system includes a front vertical support having front mounting positions. A rear vertical support has two or more rear mounting positions corresponding to each front mounting position such that each corresponding rear mounting position is a specified distance from the front mounting position. A shelf has a shelf front mounting and shelf rear mounting the specified distance apart. The shelf is assembled to the supports by mounting the shelf front mounting to the front vertical support mounting position and rotating the shelf using the front mounting position as an axis of rotation until the shelf rear mounting is mounted at one of the corresponding rear mounting positions. The shelf is substantially horizontal when mounted to one of the corresponding rear mounting positions and the shelf is angled to the horizontal in each of the remaining corresponding rear mounting positions.

This application claims the benefit of U.S. Provisional Application No. 61/449,264, filed Mar. 4, 2011, the entirety of which is incorporated herein by reference.

### BACKGROUND

1. Field of the Invention

The present invention relates generally to adjustable shelving. More particularly, the present invention relates shelving that can be adjustably positioned at a number of different heights and at a plurality of different angles to the horizontal.

2. Description of Related Art

Shelving or storage systems comprising shelves that can be installed at a plurality of different heights are well known in the art. In general, these systems feature a rack of adjustable shelves having a simple and economical shelf support mechanism. For example, a shelf is attached to four supporting vertical posts by placing each of the posts through an individually associated corner socket of the shelf. Two of the posts are associated with the front of the shelf and two of the posts are associated with the rear of the shelf. Each post has a plurality of notches or holes positioned along the length of the post. Each shelf has a mounting mechanism for attaching a corner of the shelf at one of the holes in each of the posts. The shelf can be installed at a variety of heights along the post, thereby allowing a shelf to be positioned and held at any of a number of desired heights on the post.

Typically the mounting of each shelf is either horizontal or inclined. That is, a hole, or mounting position, in the front supporting posts has a corresponding hole or mounting position in the rear posts at substantially the same height along the respective posts. As such, a shelf mounted at the corresponding mounting positions will be horizontal. A horizontal shelf may be desirable to avoid items on the shelf from falling off due to gravity as may be the case if the shelf were tilted to the horizontal.

In other shelving arrangements, the front post mounting positions have corresponding mounting positions in the rear posts that are at different heights. As such, a shelf mounted at the corresponding mounting positions will be at an angle to the horizontal. That is, the shelf will be at a tilt. A tilted shelf may be desirable to better showcase an item stored thereon or to make items stored toward the rear of the shelf more accessible.

### SUMMARY OF THE DISCLOSURE

An adjustable storage system and method of assembly includes a rear support having a plurality of rear mounting positions and a front support having a plurality of front mounting positions. Each front mounting position is a specified distance from at least two corresponding rear mounting positions and the rear mounting positions are substantially equidistant from the corresponding front mounting position. A shelf is mounted at a front mounting position and at a corresponding rear mounting position.

In an embodiment, the shelf has a shelf front mounting position and a shelf rear mounting position, the shelf front mounting position and the shelf rear mounting position are the specified distance apart. The front mounting position is mounted at the front mounting position and the shelf rear mounting position is mounted at one of the corresponding rear mounting positions.

In another embodiment, the shelf is substantially horizontal when the shelf rear mounting position is mounted at one of the corresponding rear mounting positions and the shelf is at an angle to the horizontal when the shelf rear mounting position is mounted to any of the remaining corresponding shelf rear mounting positions.

In another embodiment, the storage system includes one or more mounting pins and the rear mounting positions are rear holes in the rear support and the front mounting positions are front holes in the front support such that the rear holes and front holes are dimensioned to receive a mounting pin.

In another embodiment, the storage system includes a U-shaped bracket attached to the shelf at each shelf front mounting position and each shelf rear mounting position. A first mounting pin is inserted in a front hole and a second mounting pin is inserted in a corresponding rear hole. The shelf is assembled to the front support by a U-shaped bracket at a front mounting position capturing the first mounting pin and assembled to the rear support by a U-shaped bracket at a shelf rear mounting position capturing the second mounting pin.

In another implementation, the adjustable storage system includes a rear support having a plurality of rear mounting positions and a front support having a plurality of front mounting positions. Each front mounting position has at least two corresponding rear mounting positions.

A shelf is substantially horizontal when the shelf is mounted between a selected front mounting position a particular one of the corresponding rear mounting positions and the shelf is at an angle to the horizontal when the shelf is mounted between the selected front mounting position and other corresponding rear mounting positions.

### BRIEF DESCRIPTION OF THE DRAWINGS

FIG. 1 is an illustration of an embodiment of an adjustable storage system having shelves mounted in a horizontal position in accordance with the present disclosure;

FIG. 2 is an illustration of the embodiment of the adjustable storage system of FIG. 3 having shelves mounted at an angle to the horizontal position;

FIG. 3 is another view of the embodiment of the adjustable storage system of FIG. 3 having shelves mounted at an angle to the horizontal position;

FIG. 4 is another view of the embodiment of the adjustable storage system of FIG. 3 having shelves mounted in the horizontal position; and

FIG. 5 illustrates a detail of a mounting mechanism of a shelf to a vertical support.

### DESCRIPTION

The present disclosure describes a simple and sturdy rack of adjustable shelves in which the shelves can be quickly and easily positioned at different selected heights on a support system and also be adjustably tilted with respect to the horizontal. In this disclosure the terms shelving system and storage system are used interchangeably.

The shelving system of the present disclosure includes a plurality of front vertical supports and rear vertical supports. Each of the front and rear supports have a plurality of mounting positions along a vertical height of each post. Each of the front support mounting positions has two or more corresponding mounting positions in the rear supports.

A shelf is mounted at a particular mounting position in the front vertical supports and one of the corresponding mounting positions in the rear vertical supports. When mounted in one of the corresponding mounting positions, the shelf is horizontal. When mounted in other corresponding mounting positions, the shelf is tilted.

In one embodiment, the mounting positions are holes in the front and rear vertical supports. A mounting pin is inserted in a hole at a desired height in the front vertical supports. Similarly, a pin is inserted in a desired corresponding mounting hole in the rear vertical supports. A front part of a shelf is rotatably connected to the pins in the front vertical supports. The shelf has a rear coupling located a fixed distance from the front of the shell. The shelf can pivot using the pins in the front vertical support as an axis of rotation so that the rear coupling is connected or rests upon the pins in the rear vertical support.

Because the rear coupling of the shelf is a fixed distance from the front of the shelf, the corresponding holes in the rear vertical support for a selected mounting hole in the front vertical support are on an arc described by the fixed distance. That is, for each mounting position on the front vertical support there are at least two corresponding mounting positions on the rear vertical support each of which is a fixed distance from the selected front mounting position. A first corresponding mounting position on the rear vertical support is at a height on the rear vertical support substantially at the same height as the selected front mounting position. As such, the shelf is horizontal when the shelf is mounted to the selected front mounting position and the first rear corresponding mounting position. Additional corresponding rear mounting positions are higher than the first corresponding mounting position, although each is a fixed distance from the selected front mounting position. As such, the shelf is tilted when the shelf is mounted to the selected front mounting position and any of the additional corresponding rear mounting positions.

The shelf can have a front “rake” that is angled up so that items placed on the shelf do not fall off when the shelf is in a tilted position.

When in use, the front of a shelf can be rotatably coupled at a selected mounting position on the front vertical supports. The shelf can be rotated about the mounting position until the rear part of the shelf is coupled at the desired mounting position on the rear vertical supports.

It is understood that the front and rear mounting positions could be reversed. That is, each of the front and rear supports have a plurality of mounting positions along a vertical height of each post. Each of the rear support mounting positions has two or more corresponding mounting positions in the front supports. In this case, a first corresponding mounting position on the front vertical support is at a height on the front vertical support substantially at the same height as a selected rear mounting position. As such, the shelf is horizontal when the shelf is mounted to the selected rear mounting position and the first front corresponding mounting position. Additional corresponding front mounting positions are lower than the first corresponding mounting position, although each is a fixed distance from the selected front mounting position. As such, the shelf is tilted when the shelf is mounted to the selected rear mounting position and any of the additional corresponding front mounting positions.

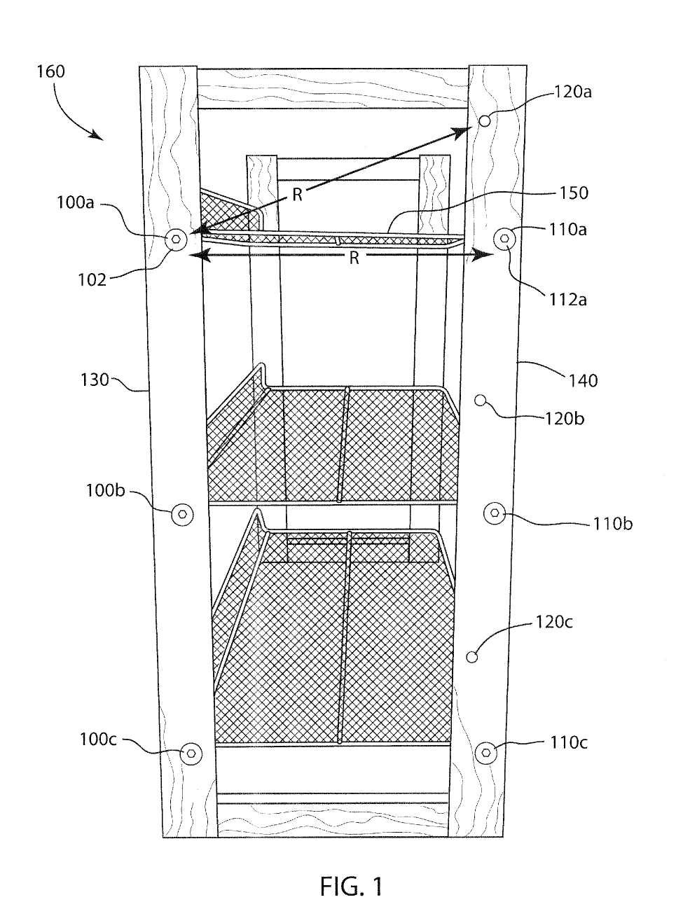

FIG. 1 illustrates an embodiment of adjustable shelving in accordance with the present disclosure. The adjustable storage system 160 has a front vertical support 130 and a rear vertical support 140. Front vertical support 130 has a plurality of front mounting positions 100a, 100b, 100c that are collinear along a height of the front vertical support.

Each front mounting position 100a, 100b, 110c has at least two corresponding rear mounting positions located on the rear vertical support 140. For example, front mounting position 100a has corresponding rear mounting positions 110a, 120a. Similarly, front mounting position 100b has corresponding rear mounting positions 110b, 120b and front mounting position 100c has corresponding rear mounting positions 110c, 120c.

As an example, corresponding rear mounting positions 110a, 120a are equidistant from the associated front mounting position 100a. As illustrated, rear mounting positions 110a, 120a are each a distance R from front mounting position 100a. That is, rear mounting positions 110a, 120a are on an arc with respect to front mounting position 100a.

Rear mounting position 110a is substantially at the same height on the rear vertical support as front mounting position 110a is on the front mounting support. Rear mounting position 120a is higher on the rear vertical support than front mounting position 110a is on the front mounting support.

A shelf 150 can be mounted at a desired height between a front mounting position and any of the plurality of corresponding rear mounting positions. For example, shelf 150 can be rotatably attached to front vertical support 130 at a hole at mounting position 100a by any suitable means such as a pin 102 inserted in the hole at the desired mounting position. Pins 102 can fit into a mating portion in the front of shelf 150. Shelf 150 may then be rotated about pin 102 to either rear mounting position 120a or 110a. A mounting mechanism, such as a pin 112a, 122a, can be inserted at a desired rear mounting position 110a, 120a, respectively, to secure a rear part of shelf 150 to rear vertical support 140.

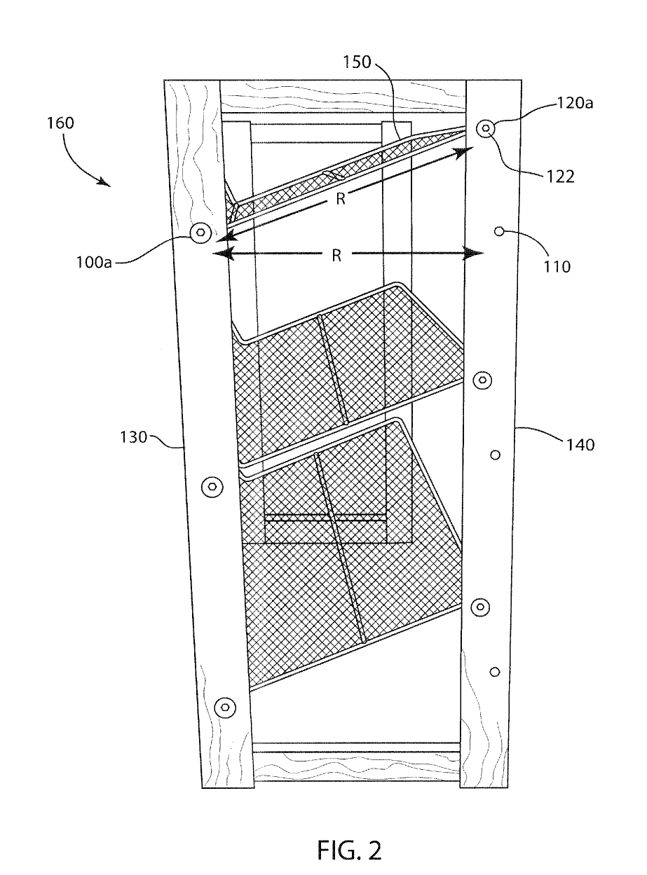

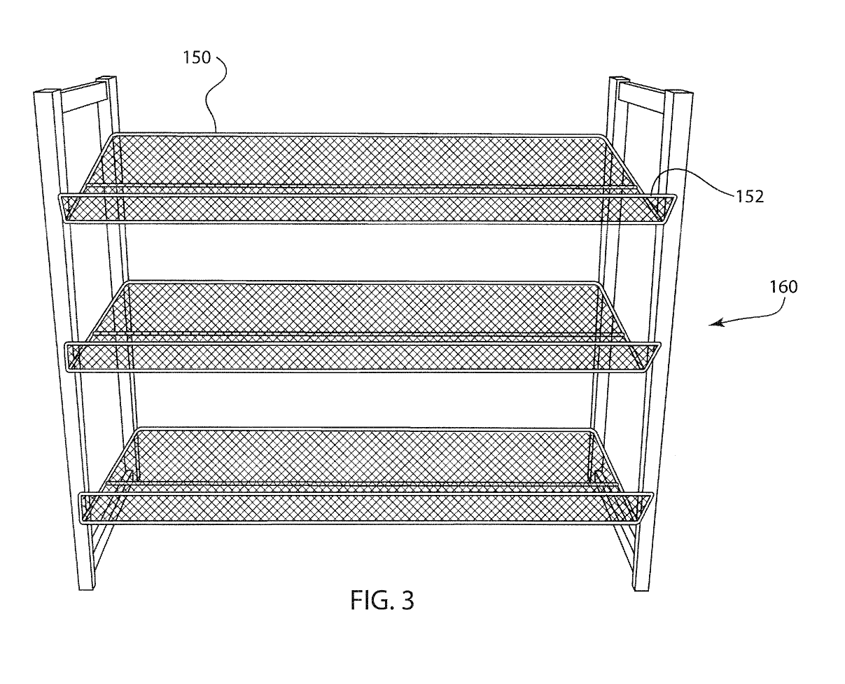

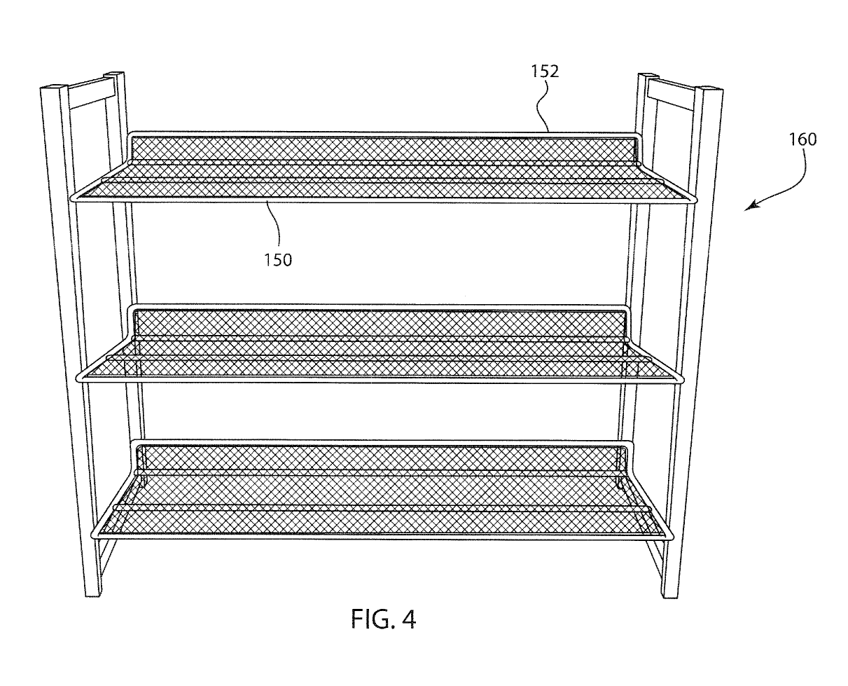

Shelf 150 will be tilted or angled with respect to the horizontal when the rear of shelf 150 is secured at rear mounting position 120a, as illustrated in FIGS. 2 and 3. Shelf 150 will be horizontal when the rear of shelf 150 is secured at rear mounting position 110a, as illustrated in FIGS. 1 and 4. FIGS. 3 and 4 also illustrate an optional rake 152 on the front of shelf 150 that can aid in retaining items on the shelf especially when the shelf is in the tilted position.

An advantage of the adjustable shelves disclosed herein that a shelf may be mounted either horizontally or tilted without altering the front or rear vertical supports. That is, the front and rear vertical supports are configured to allow mounting of a shelf either horizontally or at a tilt without altering the physical arrangement of either of the supports.

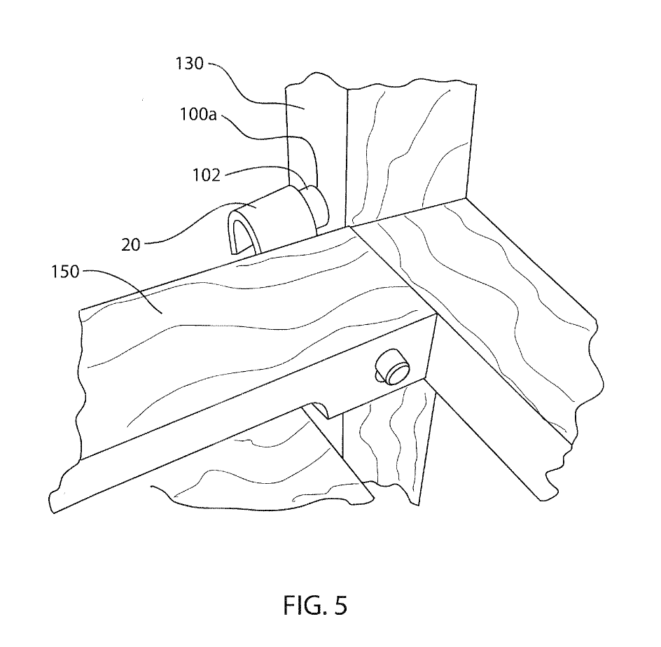

FIG. 5 illustrates a detail of one technique for assembly of a shelf that is rotatable about a mounting hole 100a. A U-shaped bracket 20 can be positioned at the front and rear of shelf 150. Shelf 150 can be mounted between the front and rear vertical supports by positioning a U-shaped bracket on the front of the shelf over pin 102 in the front vertical support and pivoting the shelf around pin 102 in the front vertical support until a U-shaped bracket in the rear of the shelf rests on a pin (not shown) in hole 120a in the rear vertical support. When so assembled, shelf 150 is tilted because the pin in the rear vertical support hole 120a is higher than the corresponding hole 110a in the front vertical support. However, a pin alternatively could be positioned in hole 110a, which also corresponds with the same hole 110a in the front vertical support as hole 120a. In this case, when shelf 150 is pivoted around pin 102 in the front vertical support until U-shaped bracket in the rear of the shelf rests on the pin in hole 110a, the shelf is horizontal because hole 110a is at substantially the same height as the corresponding hole in the front vertical support.

It should be noted that attachment mechanisms other than U-shaped brackets are contemplated. For example, the shelf could have channels in the front and rear that fit over pins 102. That is, pins 102 could be located longitudinally to shelf 150. A channel at the front of the shelf can fit over a pin 102 in a hole in the front vertical support. The rear of the shelf can have a channel to accept the pin in the rear vertical support. Accordingly, when shelf 150 is rotated about the pin in the front channel, the rear channel can mate with either of two corresponding pins in the rear vertical support. A first of the two corresponding pins is at a height higher than the pin in the front vertical support and causes the shelf to be tilted when mounted there to. A second of the two corresponding pins is at a height substantially the same as the height of the pin in the front vertical support and causes the shelf to be horizontal when mounted thereto. In an implementation, the rear of the shelf has two channels: one that accepts the first corresponding pin and a second that accepts the second corresponding pin when the shelf is rotated about the pin in the front vertical support. In an implementation, the two corresponding holes in the rear vertical support are each position on the rear vertical support the same distance from the corresponding pin in the front vertical support. That is, the two rear corresponding holes are on an arc from the associated hole in the front mounting support, as described above with respect to FIGS. 1 and 2. In another implementation, pin 102 fits through hole 100 in the front vertical support and into a mating location on shelf 150. Shelf 150 is rotatable about pin 102 and secured in position by pin 112 fitted into another mating location on shelf 150. In another implementation, pins 102, 112 are threaded and are threaded into the mating locations on shelf 150. In each implementation, the two rear corresponding holes are on an arc from the associated hole in the front mounting support.

Other embodiments are within the scope of the following claims.

I claim:

1. An adjustable storage system, comprising:
a rear support having a plurality of rear mounting positions;
a front support having a plurality of front mounting positions, each front mounting position being a specified distance from at least two corresponding rear mounting positions, said rear mounting positions being substantially equidistant from the corresponding front mounting position;
a shelf,
wherein the shelf is mounted at a front mounting position and at a corresponding rear mounting position.

2. The adjustable storage system of claim 1, wherein the shelf has a shelf front mounting position and a shelf rear mounting position, the shelf front mounting position and the shelf rear mounting position being the specified distance apart; and
wherein the front mounting position is mounted at the front mounting position and the shelf rear mounting position is mounted at one of the corresponding rear mounting positions.

3. The adjustable storage system of claim 2, wherein the shelf is substantially horizontal when the shelf rear mounting position is mounted at one of the corresponding rear mounting positions and the shelf is at an angle to the horizontal when the shelf rear mounting position is mounted to any of the remaining corresponding shelf rear mounting positions.

4. The adjustable storage system of claim 3, comprising:
one or more mounting pins;
wherein the rear mounting positions are rear holes in the rear support and the front mounting positions are front holes in the front support, and
wherein the rear holes and front holes are dimensioned to receive a mounting pin.

5. The adjustable storage system of claim 4, further comprising:
a U-shaped bracket attached to the shelf at each shelf front mounting position and each shelf rear mounting position,
where a first mounting pin is inserted in a front hole and a second mounting pin is inserted in a corresponding rear hole, and
wherein the shelf is assembled to the front support by a U-shaped bracket at a front mounting position capturing the first mounting pin and assembled to the rear support by a U-shaped bracket at a shelf rear mounting position capturing the second mounting pin.

6. An adjustable storage system, comprising:
a rear support having a plurality of rear mounting positions;
a front support having a plurality of front mounting positions, each front mounting position having at least two corresponding rear mounting positions;
a shelf,
wherein the shelf is substantially horizontal when the shelf is mounted between a selected front mounting position a particular one of the corresponding rear mounting positions and the shelf is at an angle to the horizontal when the shelf is mounted between the selected front mounting position and other corresponding rear mounting positions.

7. A method of assembling an adjustable storage system, comprising:
providing a plurality of rear mounting positions in a rear support;
providing a plurality of front mounting positions in a front support, each front mounting position being a specified distance from at least two corresponding rear mounting positions, said rear mounting positions being substantially equidistant from the corresponding front mounting position;
mounting a shelf at a front mounting position;
rotating the shelf using the front mounting positions as an axis of rotation;
mounting the shelf to a corresponding rear mounting position.

8. The adjustable storage system of claim 7, wherein the shelf has a shelf front mounting position and a shelf rear mounting position, the shelf front mounting position and the shelf rear mounting position being the specified distance apart; and
wherein the front mounting position is mounted at the front mounting position and the shelf rear mounting position is mounted at one of the corresponding rear mounting positions.

9. The method of assembling an adjustable storage system of claim 8, wherein the shelf is substantially horizontal when the shelf rear mounting position is mounted at one of the corresponding rear mounting positions and the shelf is at an angle to the horizontal when the shelf rear mounting position is mounted to any of the remaining corresponding shelf rear mounting positions.

10. The adjustable storage system of claim 9, comprising:
inserting a first mounting pin in a front hole at the front mounting position;
capturing the first mounting pin in a U-shaped bracket attached at the shelf front mounting position;
inserting a second mounting pin in a corresponding rear hole at the rear mounting position;
wherein the first mounting pin is on the axis of rotation and,
wherein the shelf is rotated about the axis of rotation until a U-shaped bracket at the shelf rear mounting position captures the second mounting pin.

11. A method of assembling an adjustable storage system, comprising:
providing a plurality of rear mounting positions on a rear support;
providing a plurality of front mounting positions on a front support, each front mounting position having at least two corresponding rear mounting positions;
a shelf,
wherein the shelf is substantially horizontal when the shelf is mounted between a selected front mounting position and a particular one of the corresponding rear mounting positions and the shelf is at an angle to the horizontal when the shelf is mounted between the selected front mounting position and other corresponding rear mounting position.
